(19) United States
(12) Patent Application Publication
(10) Pub. No.: US 2005/0066003 A1
(43) Pub. Date: Mar. 24, 2005

(54) Method and system for transferring addressable data

(76) Inventor: Jari Reinikainen, Vantaa (FI)

Correspondence Address: BIRCH STEWART KOLASCH & BIRCH, PO BOX 747, FALLS CHURCH, VA, 22040-0747, US

(21) Appl. No.: 10/499,118

(22) PCT Filed: Dec. 18, 2002
(86) PCT No.: PCT/FI02/01041

(30) Foreign Application Priority Data
Dec. 19, 2001 (FI) 20012520

(51) Int. Cl. G06F 15/16

(52) U.S. Cl. 709/206

(57) ABSTRACT

The invention relates to a method for transferring addressable data (6-2 . . . 640) via an antenna system (4-14) of a building, the method comprising receiving a broadcast television signal (INFO-1 . . . INFO_{—}5) and transferring it to the antenna system (4-14) of the building. The method further comprises bringing a terminal (4-10) of an information network (4-6) in functional connection with the antenna system (4-14) of the building, and assigning an address in the information network (4-6) to the terminal (4-10); and receiving the addressable data (6-2 . . . 6-40) with the terminal (4-10) of the information network (4-6) and converting them by means of a modulator (4-12) into a television signal, which is combined with the antenna system (4-14) of the building.

### OBJECT OF THE INVENTION

The invention relates to telecommunication technology and particularly to a method and system for transferring addressable data via an antenna system of a building, wherein a broadcast television signal is received.

### BACKGROUND OF THE INVENTION

TV programmes (TV, television) are conventionally transferred such that at the transmitting end, a TV broadcast is supplied to a TV modulator and further to a transmission unit. Via antennas of antenna towers, high power transmitters transmit the broadcast to an air link. Antennas of housing associations or buildings, for instance, which receive TV image, receive the TV broadcast, and the TV broadcast is transferred via a distribution point to TV sets of the housing association or the buildings.

In addition to terrestrial distribution, a transmission via cables can be used. Therein a signal from a TV modulator is supplied to a cable network and further to TV sets connected to the cable network. According to yet another alternative, a TV broadcast can be distributed to receivers via satellites.

What is common to the above mentioned data transmission methods is that they represent a broadcast which is directed to all places and in which a high power transmitter transmits a broadcast and all receivers within the broadcast area can receive the same broadcast.

FIG. 1 shows a prior art system for transferring TV programmes. Dark dots in FIG. 1 show high power transmitters in the area of Finland 1-100. For instance, a transmitter 1-1 represents a high power transmitter in the area of Helsinki, and its broadcast INFO_1 is distributed to a geographically large area the radius of which is 1-10, i.e. to the entire range of the transmitter. The broadcast of the transmitter is distributed identically over the entire area. Reference numeral 1-101 denotes a small part of the area 1-10, also known as a local area. TV sets inside the local area, which are known as residential areas, are marked with reference numerals 1-11 . . . 1-15.

Another transmitter 1-2 represents a high power transmitter in the area of Oulu, and its broadcast INFO_2 is also distributed to a geographically large area 1-20, i.e. to the entire range of the transmitter. The broadcast of this transmitter is also distributed identically over the entire area. Reference numeral 1-201 denotes a small part of the area 1-20, also known as a local area. TV sets inside this local area, which are known as residential areas, are marked with reference numerals 1-21, 1-22 and 1-23.

This leads to a problem that a sender can optimise the transmitted data only for the entire recipient group within the range of the transmitter and not for a single user or a limited user group. In other words, data are nowadays addressed by means of transmitter centres to wide geographical areas, as was described in FIG. 1, since the prior art data addressing would require a very dense antenna network. Therefore, information transmitted from the transmitter centre of the area of Helsinki, for instance, is shown identically in every television within the range of the transmitter, and the information transmitted from the transmitter centre of the area of Helsinki, for instance, cannot be addressed specifically to Vantaa.

Thus, the problem of the prior art arrangements is that data must be distributed to large areas. This is why, for instance, consumers do not obtain localised, such as geographically addressed services, nor can advertisers address their advertisements accurately. A broadcast cannot be addressed accurately, because it is expensive to construct antenna units for terrestrial, satellite and cable distribution to achieve a more precise distribution.

### BRIEF DESCRIPTION OF THE INVENTION

It is thus an object of the invention to provide a method and equipment implementing the method such that the above problem can be solved. The object of the invention is achieved by a method and a system, which are characterized by what is disclosed in the independent claims. The preferred embodiments of the invention are disclosed in the dependent claims.

The invention is based on:
bringing a terminal of an information network in functional connection with an antenna system of a building, and assigning an address in the information network to the terminal; and
receiving addressable data with said terminal of the information network and converting them by means of a modulator into a television signal, which is combined with the antenna system of the building.

The method and system of the invention provide the advantage that the data can be addressed accurately and precisely in an economically advantageous way. The data can be addressed with an accuracy of an antenna system of a single building.

### BRIEF DESCRIPTION OF THE FIGURES

The invention will now be described in closer detail in connection with preferred embodiments and with reference to the attached drawings, in which

FIG. 1 illustrates prior art transmission of TV programmes;

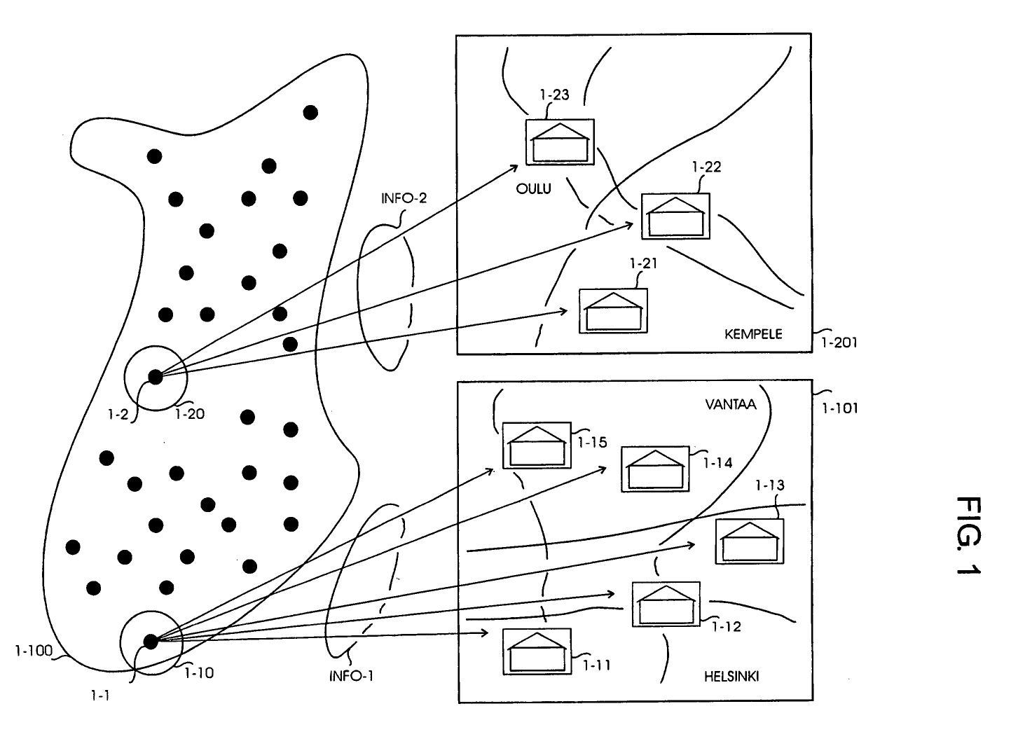

FIG. 2 illustrates data transmission according to an embodiment of the invention;

FIG. 3 illustrates a database according to an embodiment of the invention;

FIG. 4 illustrates equipment according to an embodiment of the invention;

FIG. 5 illustrates equipment according to an embodiment of the invention for transmitting an advertisement via the Internet; and

FIG. 6 illustrates an implementation of a client user interface.

### DETAILED DESCRIPTION OF THE INVENTION

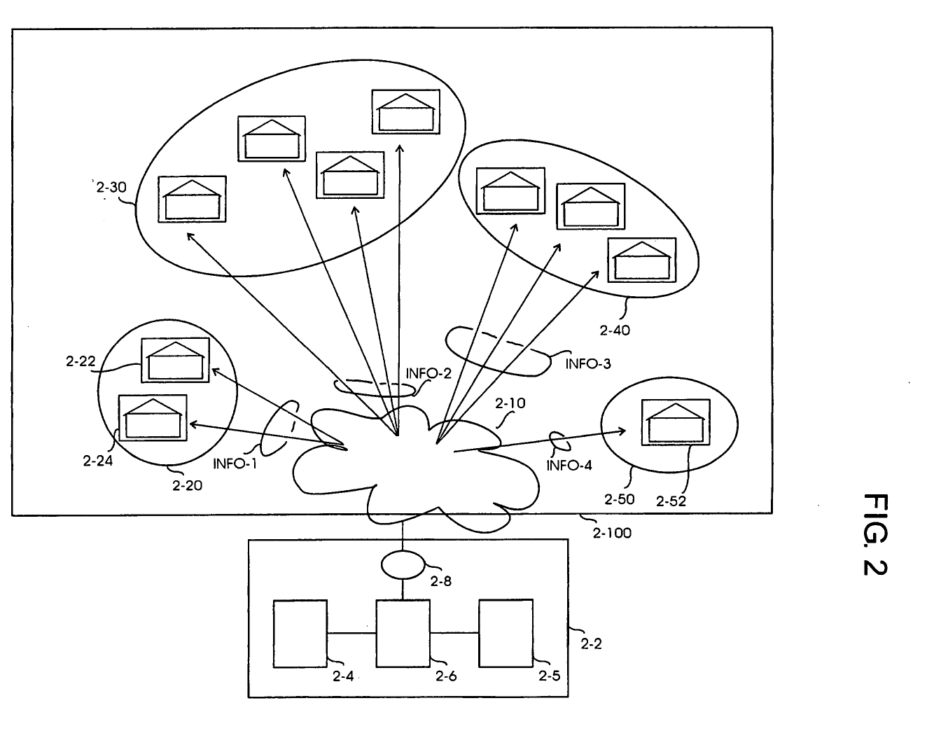

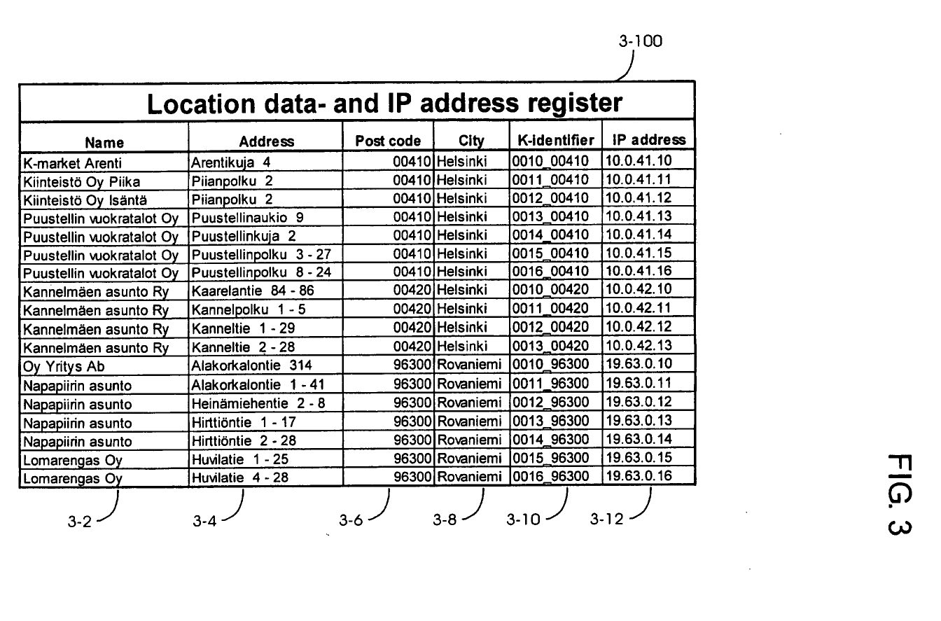

FIG. 2 illustrates data transmission according to an embodiment of the invention, whereby data in one or more servers 2-4 and 2-5 of a service management centre (SMC) 2-2 can be transferred via a switch 2-6 and a router 2-8 to an IP network 1-10. The IP network forwards data of the servers individually to residential areas connected to the IP network in a local area 2-100 so that data INFO_1 are transferred to a residential area 2-20, data INFO_2 are transferred to a residential area 2-30, data INFO_3 are transferred to a residential area 2-40 and data INFO_4 are transferred to a residential area 2-50. Thus, data transmitted to buildings 2-22 and 2-24 of the residential area 2-20 can be different from data transmitted to a building 2-52 of the residential area 2-50. Accurate addressing and transmission of different data to different buildings is possible, because different equipment have their own individual location and address data and IP addresses. In addition to data addressed according to buildings, data can also be addressed according to towns, quarters of towns, postal codes or street names. FIG. 3 illustrates a database 3-100 according to an embodiment of the invention. A database may comprise, for instance, names of buildings 3-2, street names of buildings 34, postal codes 3-6 and towns 3-8, various identification data 3-10 and IP address data 3-12. The table shows that, for instance, the building K-market Arenti having the address Arentikuja 4, 00410 Helsinki, has a building identifier 0010_{—}00410 and an IP address 10.0.41.10. It is easy to form, adapt and maintain a location data and IP address register of FIG. 3.

Information can be addressed according to the given selection criteria. Data for addressing information are stored in a database. In addition to a location data and IP address register, the database can include, for instance, branch data of companies, data on associations, or other data necessary for addressing and authenticating data. The database may also include time-dependent identifiers, such as dates and times.

Data intended to be addressed by means of the database 3-100 and other data to be included in the database can be addressed, for instance, with the following sentence: Data should be addressed to serviced flats in Vantaa for a period of Monday, 9 a.m. to Friday, 5 p.m.

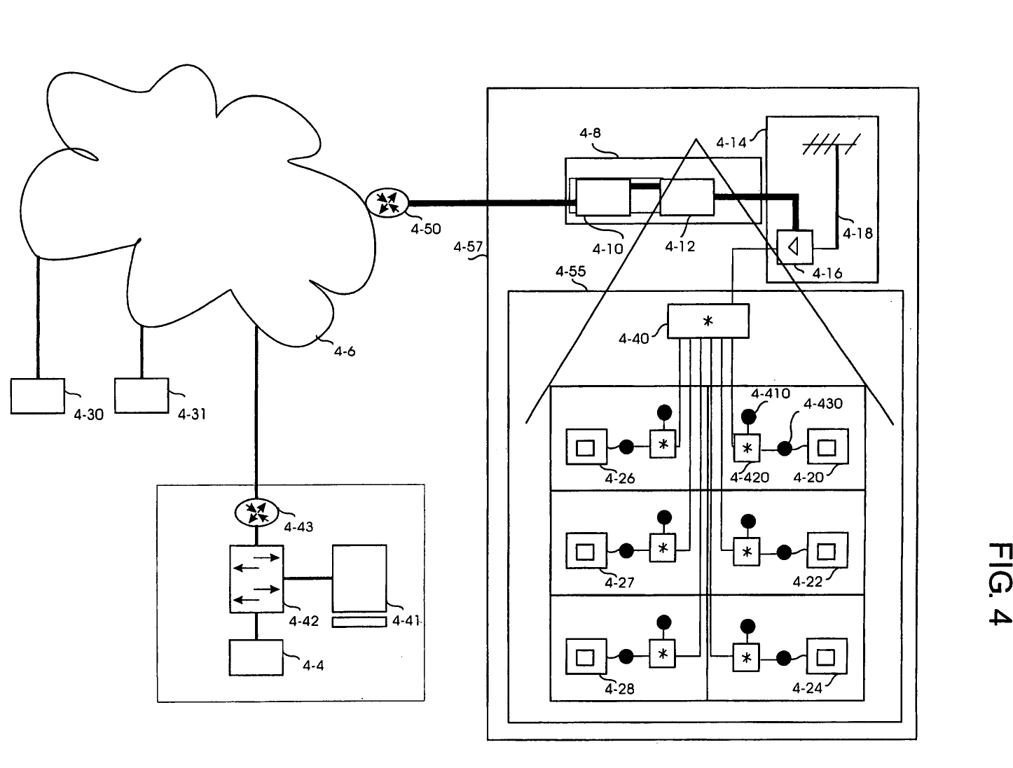

FIG. 4 illustrates equipment according to an embodiment of the invention. A service management centre 4-2, which can also be called a management centre, comprises server equipment 4-4, in which the location data and IP address database 3-100 (cf. FIG. 3) can be stored. The service management centre supervises and controls the location data and IP address database and distributes the information via a data network, such as an IP-based Internet 4-6, to a server 4-10 of a building network 4-8 of a distribution network for buildings 4-57. A function of the server of a building-specific building network is, in fact, distributing information locally. Other examples of networks over which addressable data can be transmitted include a public switched telephone network, integrated services digital network ISDN, local area network, mobile communication network and professional mobile radio.

The service management centre 4-2 can also comprise control software 4-41, a repeater 4-42 and a router 4-43. The function of the repeater 4-42 is to connect the equipment to each other by using Ethernet technology, for example, and the function of the router 4-43 is to guide IP traffic to proper target addresses. With a router or a corresponding device, a virtual private network VPN can, if desired, also be formed above public networks on the basis of addresses used in the location data register.

The function of a modulator 4-12 of the building network is to adapt the information to the antenna network, antenna system 4-14 of the building. The need for using a modulator depends on the structure of the antenna network of the building and the technology used, for instance. Via the modulator, the information is distributed to an antenna amplifier 4-16 of the antenna system 4-14 of the building. By using the antenna amplifier, the signal of the information sources can be amplified. The antenna system typically also contains a conventional TV antenna 4-18 and/or a satellite antenna for receiving TV broadcasts.

Reference numerals 4-20, 4-22, 4-24, 4-26, 4-27 and 4-28 denote six different TV sets of a home network 4-55, which sets can be located either in different apartments or in one apartment. The received broadcast signal has a certain frequency range, which can be divided into frequency bands. Each frequency band corresponds to a certain TV broadcast, TV channel. The modulator 4-12 modulates, i.e. converts a video signal transmitted to a local server over the data network into a signal suitable for the antenna network, e.g. into a UHF signal (Ultra High Frequency), and the data can be adapted to one or more TV channels, the channel being determined for each area, i.e. according to transmission areas, on the basis of channels available, for instance. Typically, the frequency range of the channel, to which the data are adapted, is not reserved for following a TV broadcast. This TV channel can be called a data channel. Thus, TV sets according to FIG. 4 can be used for following the data channel.

If data need be addressed even more accurately, e.g. specifically to each apartment, the building network 4-8 can be provided with as many modulators as the building has apartments. In this case, data to be transmitted over the IP network can be provided with an identifier, on the basis of which the modulators can modulate different data to different TV channels for different apartments. The information produced according to the invention and its preferred embodiments can even be addressed specifically to each set so that each television shows different information.

However, no TV set is required to receive information. There are many alternative terminals and user interfaces, e.g. a home computer or a mobile phone provided with a video card. Also a radio set can function as a terminal, for instance, in such a manner that a voice synthesizer speaks the data received.

Servers marked with reference numerals 4-30 and 4-31, wherein the material of an information provider can be stored, can communicate directly via the Internet 4-6 with the distribution network for buildings 4-57, which can comprise several terminals. In a building, the information can be distributed in the above manner to an amplifier centre 4-16 of the building, from which the information is distributed to a star point 4-40 of the building and to an apartment-specific star point. From an apartment-specific star point 4-420, for instance, the information is transferred via an antenna socket 4-410, 4-430 to a terminal 4-20 of the apartment.

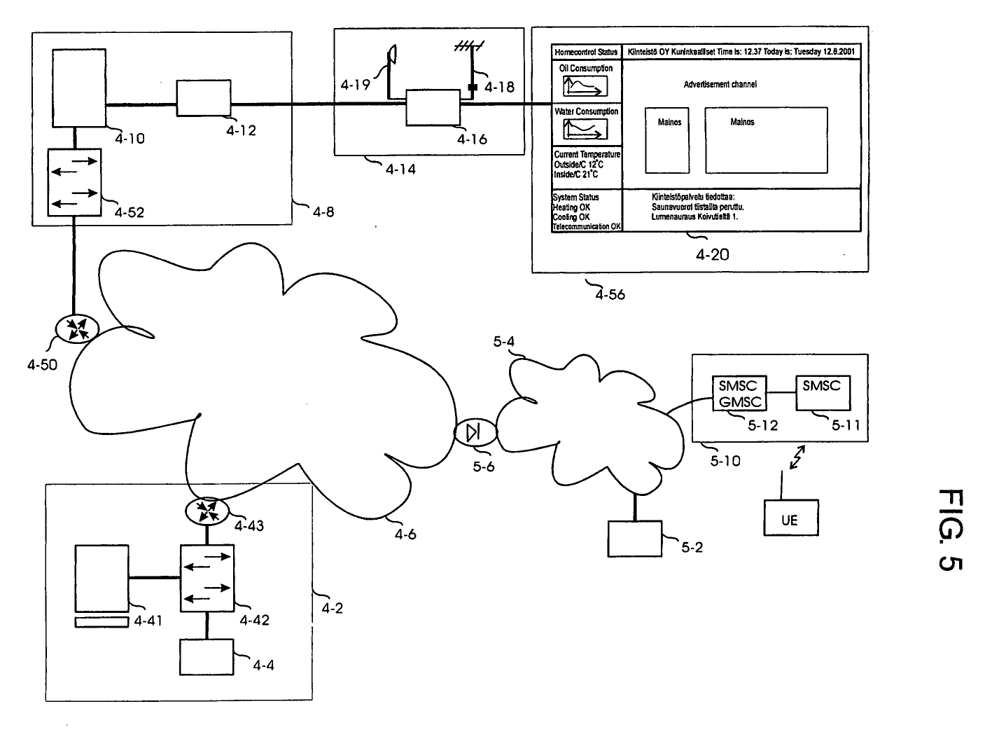

FIG. 5 illustrates equipment according to another embodiment of the invention for transmitting an advertisement via the Internet. In this case, material which a local information provider, such as a corner shop or an advertising agency, produces and forwards as an e-mail message, for instance, is stored in a server 5-2, from which it is transferred via an Internet 5-4, a hub 5-6 and an Internet 4-6 to a service management centre 4-2.

As an alternative or in addition to the above, information can be transmitted to a TV screen in a text message, i.e. a short message (SM). An information sender UE (User Equipment) sends a short message, which is passed from a short message service centre (SMSC) 5-11 of a telecommunication network 5-10 via a gateway mobile services switching centre for short message service (SMSGMSC) 5-12 and the Internets 4-6 and 5-4 to the recipient 4-2. Besides the above mentioned external short message service centre, the short message service centre can be a local short message service centre in a local server of a housing association, for instance, or in a service management centre in connection with a central server.

At the receiving end, the server 4-4 decodes the received short message and can supply the contents of the short message to the control software 4-41. With the software, a programme supervisor can observe the messages received and, if necessary, delete them. Censoring may be necessary, because the message operator is responsible for not transferring, for instance, criminal or improper messages in the programme. By scanning the messages, the supervisor can also supervise that the messages relate to a specific subject, which is, for instance, predetermined. Thereafter, the short messages which have been accepted by the control software can be supplied, as was described above, via the IP network to the building-specific server 4-10 and further to the TV modulator 4-12, the antenna system 4-14 and the terminal 4-20 of the home network 4-56. The gateway MSC for short message service can also communicate directly with the server 4-10 of the building. Correspondingly, reference numerals 4-50 and 4-52 denote a router from a building to the IP network 4-6, and a possible repeater of the building.

Other possible ways of supplying data to be transferred to terminals to a telecommunication system is, for instance, to use at least one of the following ways: voice mail message, message of Internet-based applications, multicast distribution of IP networks, multimedia message, SIP message (Session Initiation Protocol), WAP message (Wireless Application Protocol) and/or message, which is an arbitrary combination of the above manners.

According to a preferred embodiment of the invention, advertisers can offer inexpensive or free communication interfaces to house residents by offering a connection from a home computer to a hub 4-52 of a local server, for instance. In this case, the home computer can be provided, for example, with a non-switched connection or with a WLAN connection (Wireless Local Area Network) to the hub 4-52 of the local server of the building, and the advertiser can pay for the costs caused by the connection, the advertisements and announcements of which can be shown on a home computer or TV set.

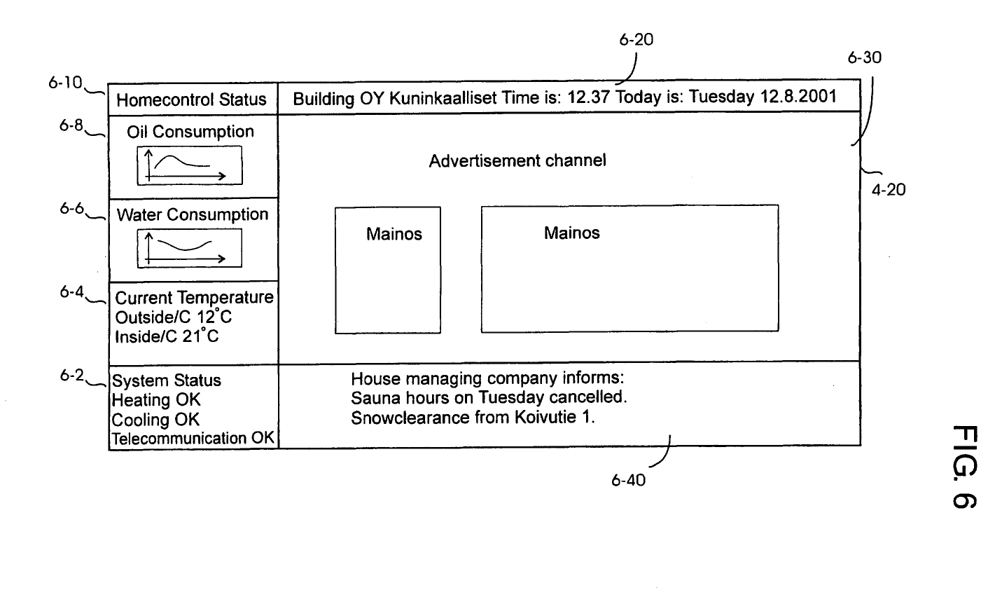

FIG. 6 shows a client user interface 4-20 . . . 4-28. As was mentioned above, the user interface can be a TV set, for instance, or a home computer with a TV card. The user interface can be divided into a plurality of fields 6-10, 6-20, 6-30 and 6-40. The fields of the user interface can contain data, for instance, on system status 6-2, current inside and outside temperatures 6-4, water consumption 6-6 or oil consumption 6-8 of the housing association and/or its joint owner during the last seven days. Field 6-20 can show data on time and date. In field 6-30, a grocery store may advertise its products and services. In field 6-40, a house managing company may inform on cancellation of sauna hours or on snow clearance. The number, appearance or contents of the fields are not restricted to the above examples, but all fields can contain, for instance, multimedia or include only text.

Data in the fields can typically change in the course of time, for instance, so that when a shop advertises that a litre of milk is cheap only on Monday and Tuesday next week, the advertisement can be seen in the data channel only during a few preceding days and/or during the period the special offer is valid. The data in the fields can also change so that the advertisements of a first advertiser can be seen in the data channel for 3 minutes, after which the advertisements of a second advertiser can be seen in the data channel for 3 minutes etc.

With the invention, data can be addressed very accurately by using a broadcast network. Data are addressed over the IP network. It is easy to implement the addressing technically, because the equipment mounted in the building has its own individual IP address and/or location and address data. The data can thus be addressed specifically to each building or apartment. Alternatively, data can be addressed, for instance, specifically to counties, towns, quarters of towns, postal codes or street names.

Since, according to the invention and its preferred embodiments, localised services can be provided, the invention adds an alternative way of advertising to conventional regional paper advertisements and even makes paper advertisements unnecessary.

User groups of the invention may include house managing companies, building companies and residents, hospitals, schools, old people's homes, private homes and advertisers. In addition, the invention and its preferred embodiments support the common social orientation, in which people are more active in discussing through different forums. To telephone network group calls, news pages of Internet servers and short message news groups of mobile networks, the invention and its preferred embodiments add an easy way of communicating, because every resident of a housing association, for instance, can now participate in the discussion concerning his/her own housing association with his/her own mobile station by sending short messages to a service management centre, to the programme production site, in order to ask questions or comments concerning the matters of the housing association. The personnel of the service management centre select the suitable contacts and forwards them.

It is obvious to a person skilled in the art that as technology advances, the basic idea of the invention can be implemented in various ways. The invention and its embodiments are thus not restricted to the above examples but they may vary within the scope of the claims.

1. A method for transferring addressable data via an antenna system of a building, the method comprising:
receiving a broadcast television signal and transferring it to the antenna system of the building,
the method further comprising
bringing a terminal of an information network in functional connection with the antenna system of the building, and assigning an address in the information network to the terminal; and
receiving the addressable data with said terminal of the information network and converting them by means of a modulator into a television signal, which is combined with the antenna system of the building.

2. A method as claimed in claim 1, further comprising maintaining a table, which associates name and/or owner and/or address and/or other identification data of the terminal with address data of the terminal.

3. A method as claimed in claim 1, further comprising combining the addressable data with the antenna system of the building by mixing the addressable data converted into a television signal with the broadcast television signal substantially to the same frequency range in an antenna amplifier.

4. A system for transferring addressable data via an antenna system of a building, the system comprising:
means for receiving a broadcast television signal and for transferring it to the antenna system of the building,
wherein the system further comprises
a terminal of an information network, which terminal is brought in functional connection with the antenna system of the building and to which terminal an address is given in the information network; and
a modulator adapted to convert the addressable data received with the terminal of the information network into a television signal, which is combined with the antenna system of the building.
